(19) United States
(12) Patent Application Publication
(10) Pub. No.: US 2007/0190315 A1
(43) Pub. Date: Aug. 16, 2007

(54) Metal element coated with a coating layer comprising an inherently conductive polymer

(76) Inventor: Johan Vanbrabant, Zwevegem (BE)

Correspondence Address: FOLEY AND LARDNER LLP;SUITE 500, 3000 K STREET NW, WASHINGTON, DC, 20007, US

(21) Appl. No.: 10/591,537

(22) PCT Filed: Feb. 28, 2005
(86) PCT No.: PCT/EP05/50846

§ 371 Date: Jan. 4, 2007

(30) Foreign Application Priority Data
May 4, 2004 (EP) 04100884.8

(51) Int. Cl. B32B 15/04; G11B 5/64

(52) U.S. Cl. 428/336; 428/457; 428/462

(57) ABSTRACT

The invention relates to a metal element coated at least partially with a self-assembled coating layer. The self-assembled coating layer comprises an inherently conductive polymer and at least one negative group. The inherently conductive polymer is functioning as a backbone structure for said negative group. The invention further relates to an article comprising at least one such metal element embedded in a polymer material.

### FIELD OF THE INVENTION

The invention relates to a metal element coated with a coating layer comprising an inherently conductive polymer and at least one negative group.

The invention further relates to an article comprising at least one metal element embedded in a polymer material.

### BACKGROUND OF THE INVENTION

Inherently conductive polymers (ICP's) are known in the art (B. Wessling, From conductive polymers to organic metals, Chemical Innovation, 2001, V 311, N1 (jan), p. 34-40).

They have been proposed as corrosion inhibitors. However, in many cases, as the metal reactivity increases, the corrosion rate increases also and hence, counteracts the inhibitive action of the inherently conductive polymers.

According to the IUPAC recommendations of 1994, the term reactivity as applied to chemical species (in this case a metal substrate) expresses a kinetic property (in this case the kinetics of mass loss during a corrosion reaction).

A species is said to be more reactive or to have a higher reactivity than some other (reference) species if it has a larger rate constant for a specified elementary reaction.

A fast indication of the reactivity can be found in the measurement of the corrosion potential, but a more reliable analysis is the measurement of the potential current relationship of a metal in a corrosive environment according to the Butler-Volmer relationship and/or as plotted in an Evans diagram.

The metal reactivity may be increased by machining, by increasing the surface roughness and/or by deforming the metal. As a consequence, inherently conductive polymers can show an unacceptable adhesion to metal substrates and they offer only limited success as anti-corrosion coating on metal substrates.

### SUMMARY OF THE INVENTION

It is an object of the present invention to provide a coating layer avoiding the drawbacks of the prior art.

It is another object of the invention to provide a coating layer that can be tailored for certain applications such as applications requiring a superior corrosion resistance.

It is a further object of the invention to provide an article comprising at least one metal element embedded in a polymer material characterised by a good adhesion between the metal element and the polymer material.

According to a first aspect of the present invention, a metal element coated at least partially with a self-assembled coating layer is provided. The self-assembled coating layer comprises an inherently conductive polymer and at least one negative group. The inherently conductive polymer is thereby functioning as a backbone structure for the negative group.

Possibly, the inherently conductive polymer is functioning as a backbone structure for two or more negative groups.

For the purpose of this invention a self-assembled coating layer means a coating layer spontaneously assembled from the monomers having a repetitive non-crystalline ordered structure.

Preferably, the self-assembled coating layer is formed by electrochemical anodic polymerisation starting from a solution of a monomer of an inherently conductive polymer and at least one dopant. The negative group of the self-assembled coating layer is derived from the dopant.

Preferably, the inherently conductive polymer is polymerised on the metal element. Most preferably, the inherently conductive polymer is polymerised in situ on the metal element.

With in situ polymerisation is meant that the polymerisation occurs in the application bath comprising a monomer solution of an inherently conductive polymer and at least one dopant.

The metal element is thereby functioning as anode during polymerisation. A great advantage of the in situ polymerisation is that the application of the coating can be done in line with other production steps such as cleaning or metal transformation such as drawing.

Generally, inherently conductive polymers (ICP's) are organic polymers that have poly-conjugated π electron systems (e.g. double bonds, aromatic or heteroaromatic rings or triple bonds). ICP's are able to conduct an electrical current due to a specific conjugated structure in the molecule.

Examples of suitable ICP's are polyaniline, polypyrrole, polythiophene, polyphenylenevinylene, polydiacetylene, polyacetylene, polyquinoline, polyphenylenevinylene, polyheteroarylenvinylene and derivatives, copolymers and mixtures thereof.

As negative groups in principle any organic or inorganic negative group or molecule can be considered as for example groups or molecules having a negative charge or groups or molecules containing at least one atom which is nucleophilic oriented due to a free electronpair on the atom, resulting in a high electrondensity: e.g. oxygen, sulphur, nitrogen.

Examples of negative groups comprise for example phosphate, sulphate, chromate, molybdate, permanganate, silicate, nitrate, sulfonate, oxalate, formiate and thiol.

Examples of negative molecules having a high electrondensity comprise for example silanes, thiophenes, thiophthenes, organic sulfides, e.g. thiophenol.

The negative group is preferably a group interacting with the metal element in order to increase the corrosion resistance of the metal element by increasing the electrochemical potential of that specified metal. The potential of the metal is increased until a passive behavior is reached; e.g. for steel preferred negative groups are phosphate, chromate or nitrate.

According to the method of the present invention, the corrosion resistance of the metal element is improved as the passivity of the metal element is increased. The increased passivity amplifies the corrosion protection already generated by the inherently conductive polymer due to the increase of the potential into the passive area of the metal element.

The negative group or groups are preferably present in a concentration between 0.01 and 50 wt % of the coating layer. More preferably, the concentration of the negative group or groups is between 0.1 and 10 wt %.

The thickness of the self-assembled coating layer is preferably between 1 nm and 1000 nm, for example between 10 nm and 100 nm.

The self-assembled coating according to the present invention has a low porosity.

For the purpose of the invention, porosity is defined as the percentage of coverage of the metal element with the self-assembled layer.

The porosity of the self-assembled layer can be determined based on electrochemical detection of iron dissolution of the substrate in an acidic medium.

Porosity analysis showed a porosity of less than 1% for a self-assembled layer having a thickness of 100 nm. For a self-assembled layer having a thickness of 1000 nm no porosity was observed (porosity less than 0.001%).

According to an embodiment of the present invention, the self-assembled coating layer, comprising an inherently conductive polymer and at least one negative group, can function as a backbone structure for a positive group such as a positive ion.

Possibly, the self-assembled coating layer is functioning as a backbone structure for two or more positive groups.

The positive ion can be chosen to influence the properties of the coating layer, for example to optimise the adhesion characteristics of the coating layer to a polymer material in which the metal element is embedded.

The positive ion is preferably selected from the group consisting of the transition elements in the periodic table of elements, the earth alkali elements and the elements from group III and IV, such as Mg, Ca, Sr, Ba, V, Cr, Fe, Co, Ni, Cu, Zn, Zr, Mo, Cd, Ce, Al and Sn.

The selection of the positive ion is based on the polymer material to which it should react.

In case the polymer material comprises rubber, cobalt is a preferred ion. Zinc can be preferred in case an increase in corrosion protection is desired.

The positive ion is preferably present in a concentration ranging between 0.01 to 5 wt %. More preferably, the ion is present in a concentration between 0.04 to 0.15 wt %.

In case the coating layer is doped with more than one positive ion, each positive ion is present in a concentration between 0.01 and 5 wt %.

Contrary to inherently conducting polymer coatings known in the art, the inherently conducting polymers used in the coating layer according to the present invention is used as a backbone structure for the negative group or groups and possibly also for the positive group.

By choosing the negative group and the positive ion, the characteristics of the coating layer such as the adhesion and/or corrosion characteristics can be influenced.

The metal element may comprise an elongated metal element or a metal structure comprising at least one elongated metal element.

As elongated metal element, a metal wire, a metal cord, a metal tape or ribbon can be considered.

The elongated metal element may have any cross-section such as a circular, oval or flat (rectangular) cross-section.

The tensile strength of a metal element is preferably higher than 1500 N/mm². The range of the tensile strength is for example between 1500 and 4000 N/mm².

It may be desired to use metal cords having a structural elongation.

As metal structure any structure comprising a number of elongated metal elements can be considered. Examples of metal structures comprise woven, non-woven, braided, knifted or welded structures.

Any metal or metal alloy can be used to provide the metal elements of the composite article according to the invention. Preferably, the metals or metal alloys are selected from iron, titanium, aluminium, copper and alloys thereof.

Preferred alloys comprise high carbon or stainless steel alloys.

The metal element or the structure comprising a number of metal elements can be coated with one or more metal or metal alloy coating before the coating layer according to the present invention is applied. Preferred metal or metal alloy coatings comprise zinc and zinc alloy coatings such as zinc-copper, zinc-aluminum, zinc-manganese, zinc-cobalt alloy, zinc-nickel alloy, zinc iron alloy or zinc-tin alloy coatings A preferred zinc-aluminum coating comprises a zinc coating comprising 2 to 10% Al and possibly 0.1 to 0.4% or a rare earth element such as La and/or Ce.

According to a second aspect of the present invention, an article comprising a metal element as described above embedded in a polymer material is provided.

Any thermoplastic material can be considered as polymer material. Examples comprise polyolefins such as polyethylene or polypropylene; polyamides; polyurethanes; polyesters; rubbers such as polyisoprene, chloroprene, styrene-butadiene, butyl rubber, nitrile and hydrogenetated nitrile rubbers, EPDM, ABS (acrylonitrile butadiene styrene) and PVC.

According to a third aspect of the present invention, a method to coat a metal element with a self-assembled coating layer is provided. The method comprises electrochemical anodic polymerisation starting from a solution of a monomer of an inherently conductive polymer and at least one dopant. The self-assembled coating layer comprises an inherently conductive polymer and at least one negative group. The negative group is derived from the dopant. The inherently conductive polymer is functioning as a backbone structure for the negative group.

In a preferred embodiment, the inherently conductive polymer is applied in situ on the metal element. With in situ polymerisation is meant that the polymerisation occurs in the application bath comprising a monomer solution of an inherently conductive polymer and at least one dopant. The metal element is thereby functioning as anode during polymerisation.

According to another aspect of the present invention a method to improve the corrosion resistance of a metal element is provided. The method comprises applying a self-assembled layer on a metal element. The self-assembled layer comprises an inherently conductive polymer and at least one negative group. The inherently conductive polymer is functioning as a backbone structure for the negative group and the negative group is chosen in such a way to increase the corrosion resistance of the metal element.

According to the method of the present invention, the corrosion resistance of the metal element is improved as the passivity of the metal element is increased. The increased passivity amplifies the corrosion protection already generated by the inherently conductive polymer due to the increase of the potential into the passive area of the metal element.

To improve the corrosion resistance of the metal element, preferred negative groups are selected from the group consisting of phosphates, chromates, nitrates, oxalates, benzoates and citrates.

According to a further object of the present invention, a method to improve the adhesion of a self-assembled layer applied on a metal element to a polymer material is provided.

The method comprises applying a self-assembled layer on a metal element. The self-assembled layer comprises an inherently conductive polymer and at least one negative group. The self-assembled layer is functioning as a backbone structure for a positive ion or group. The positive ion or group is chosen in such a way to increase the adhesion with the polymer material.

A method to improve the adhesion of a metal element to a polymer material is provided.

The method comprises the application of a self-assembled layer on a metal element and embedding this metal element with the self-assembled coating layer in a polymer material. The self-assembled coating layer comprises an inherently conductive polymer and at least one negative group. The self-assembled coating layer is functioning as a backbone structure for at least one positive group or ion. The positive group or ion is chosen in such a way to improve the adhesion with the polymer material.

The polymer material comprises preferably a thermoplastic material. Any thermoplastic material can be considered as polymer material. Examples comprise polyolefins such as polyethylene or polypropylene; polyamides; polyurethanes; polyesters; rubbers such as polyisoprene, chloroprene, styrene-butadiene, butyl rubber, nitrile and hydrogenetated nitrile rubbers, EPDM, ABS (acrylonitrile butadiene styrene) and PVC.

The positive ion is preferably selected from the group consisting of the transition elements of the periodic table of elements, the earth alkali elements and the elements from group III and IV.

In case the polymer material comprises rubber, cobalt is a preferred ion.

### BRIEF DESCRIPTION OF THE DRAWINGS

The invention will now be described into more detail with reference to the accompanying drawings wherein

FIG. 1 shows an example of a polymerisation reaction of a inherently conductive polymer;

FIG. 2 shows an example of a polymerisation reaction whereby an inherently conductive polymer is functioning as a backbone structure for a negative group;

FIGS. 3 and 4 show two embodiments of the electrochemical in situ application of a coating layer according to the present invention;

FIG. 5A to FIG. 5D show metal elements coated with a coating layer according to the present invention.

### DESCRIPTION OF THE PREFERRED EMBODIMENTS OF THE INVENTION

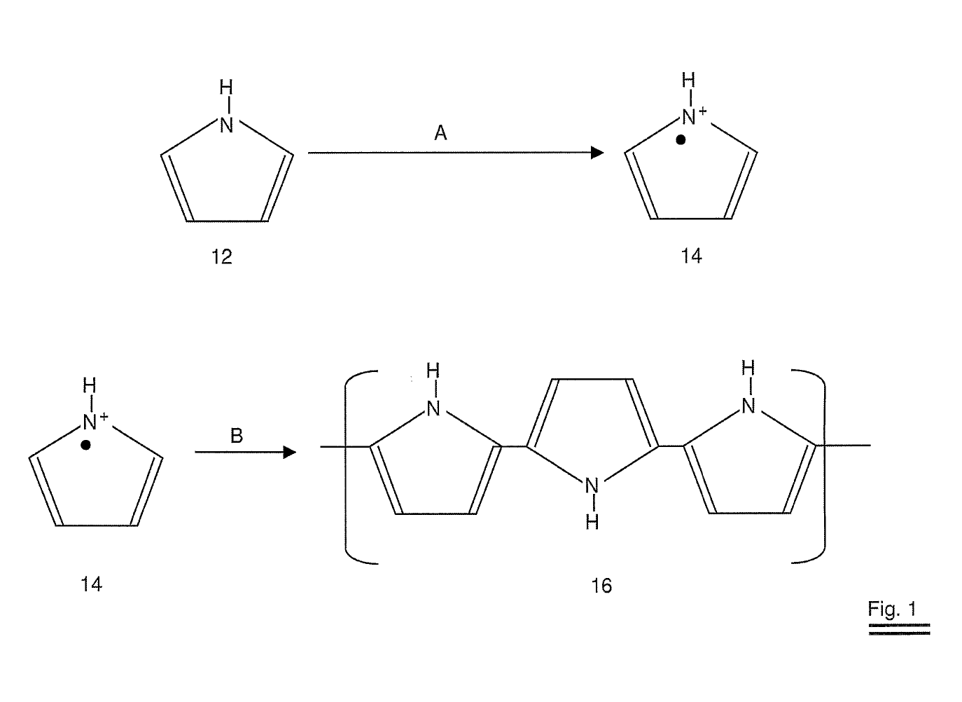

FIG. 1 shows an example of a polymerisation reaction:
step A comprises the electrochemical oxidation of the monomer 12 to form radical 14;
step B comprises the polymerisation of the monomer 14 to form the polymer 16 (polypyrrole).

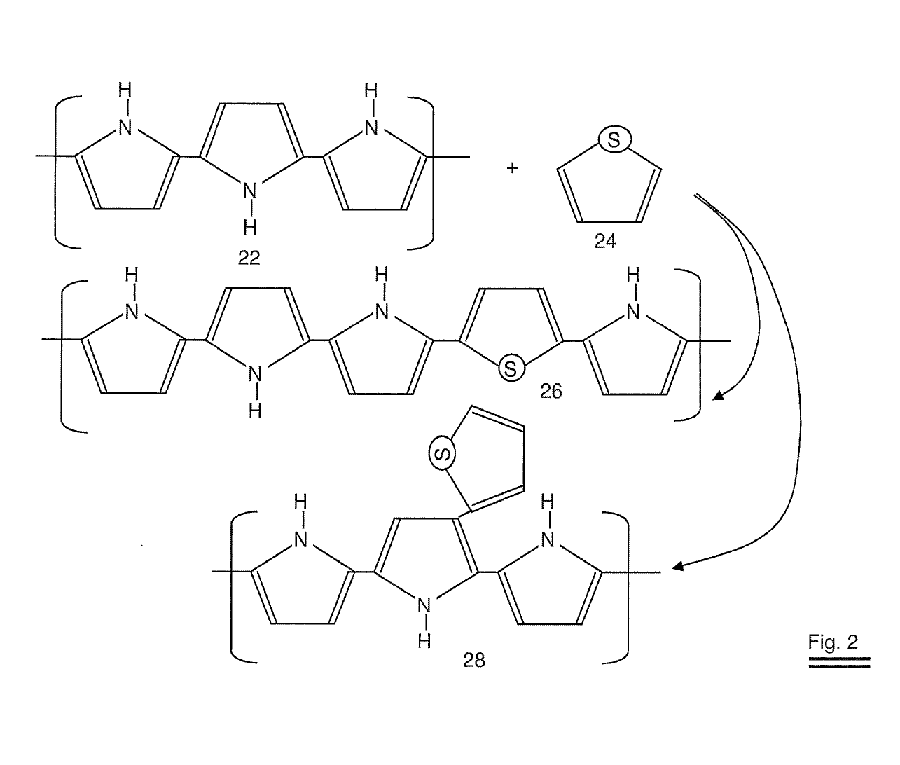

FIG. 2 shows the addition of a negative group 24 within the polymer structure 22 to form the structure 26 or 28.

In the example shown in FIG. 2, thiophene is added to a polypyrrole structure. Thiophene is chosen to increase the adhesion of the metal element to the polymer (rubber) in which the metal element is embedded.

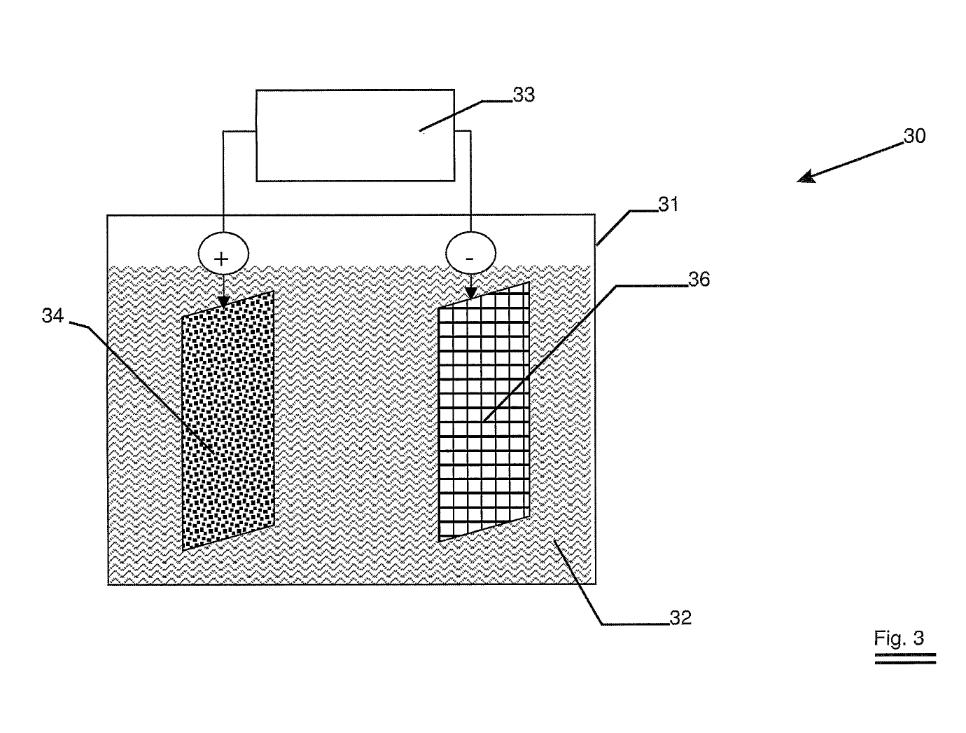

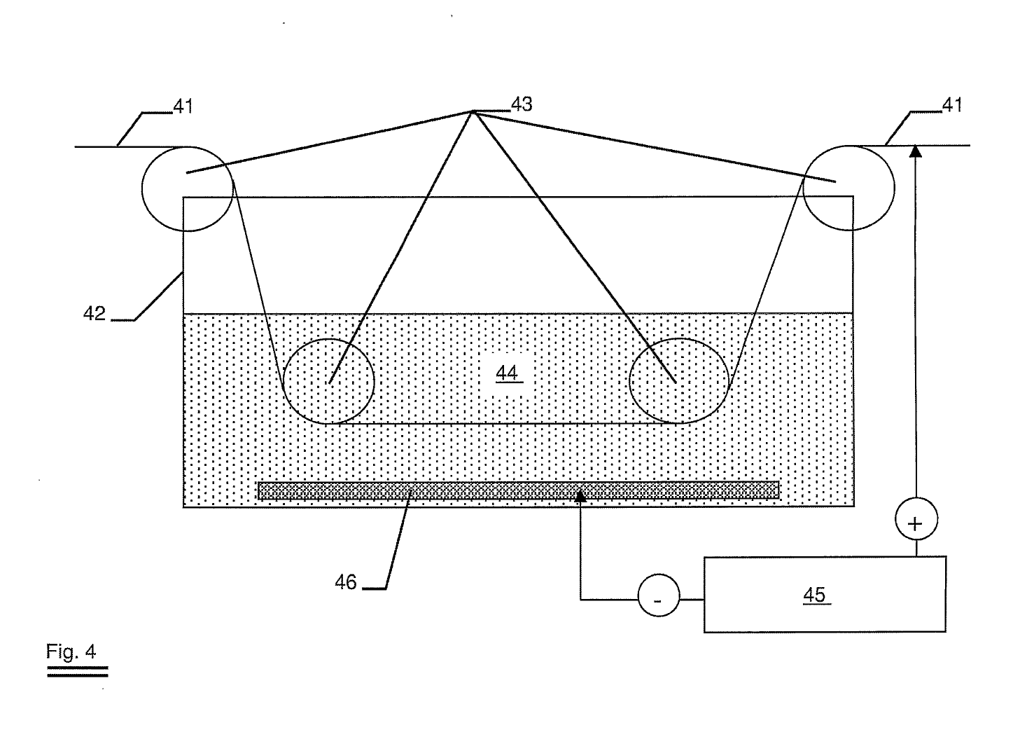

FIGS. 3 and 4 show two embodiments of the electrochemical in situ application of a coating layer according to the present invention. FIG. 3 shows a batch process for the application of the coating layer, whereas FIG. 4 shows a continuous process.

As shown in FIG. 3, the substrate to be coated 34 is placed in a bath 31. The bath comprises a solution 32 comprising an inherently conductive polymer and all other constituents of the coating layer. A power source 33 is negatively connected to a counter electrode 36 (the cathode) and positively connected to the metal element to be coated 34. The substrate to be coated 34 is functioning as anode.

FIG. 4 shows a continuous method for the application of a coating layer according to the present invention on an elongated metal element such as a steel wire.

The steel wire 41 is introduced in a bath 42 thereby guided by rolls 43. The bath 41 comprises a solution 44 comprising an inherently conductive polymer and all other constituents of the coating layer. A power source 45 is negatively connected to a counter electrode 46 (the cathode) and positively connected to the steel wire 41. The steel wire 41 is functioning as anode.

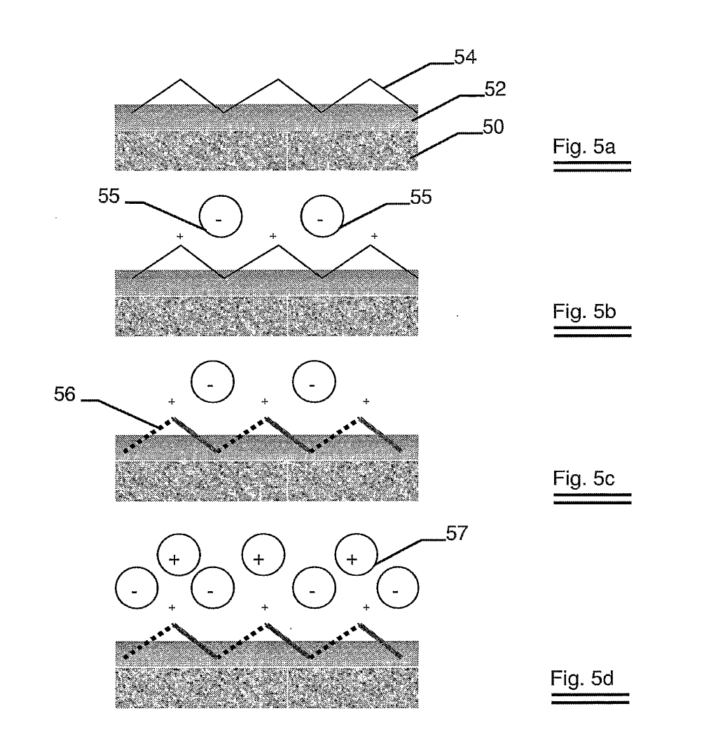

FIG. 5a shows a metal element 50 having an oxide layer 52. The metal element is coated with a coating layer 54 according to the present invention. The coating layer 54 comprises an ICP forming a backbone structure.

In the coating layer of FIG. 5b, counter ions 55 are added to the backbone structure 54.

In the embodiment of FIG. 5c, the coating layer 54 is further tailored by adding one ore more organic radical 56 such as thiophene in the backbone structure 54.

In the embodiment of FIG. 5d positive metal ions are added to further influence the characteristics of the coating layer. As an example, Co²⁺ is added to increase the adhesion of the coating layer 54 to rubber.

Some examples of steel wires with a coating layer according to the present invention are tested and are compared with a non-treated steel wire.

Examples 1 to 8 illustrate the influence of a coating layer according to the present invention on the corrosion resistance of a steel wire, examples 9 to 12 illustrate the influence of a coating layer according to the present invention to four different rubber compounds.

The steel wires are manufactured as follows. Starting from a rod wire, the wire is drawn in one or more steps until the desired diameter is obtained. Subsequently, the steel wires are coated with a coating layer according to the present invention by a method as shown in FIG. 4. The application solution is prepared starting from a monomer solution. The solution can be made in an inorganic solvent such as water or in an organic solvent such as propylenecarbonate, acetonitrille, methanol, ethanol, propanol, aceton or other solvents. The selection of the solvent depends upon the application. For certain metal elements, such as carbon steel substrates, water is preferred. For metal elements like aluminum, titanium or alloys like stainless steel organic solvents are preferred.

The corrosion behaviour of the tested steel wires is simulated and determined according to the standard procedure: Corrosion tests and standards: application and interpretation, ASTM MNL 20, pp. 75-80, ASTM G3-89, ASTM G5-82, ASTM G15-85a and ASTM STP 727.

For the analysis of the corrosion behaviour, the polarisation resistance Rp is measured. The higher the value of Rp, the better the corrosion resistance.

Another parameter, next to the value of the polarisation resistance Rp, is the so-called “inhibition rating” as defined in “Compendium of Chemical Terminology”, IUPAC Recommendations, Blackwell Scientific Publications, 1987, p. 198:
I=(V₀−V)/V₀
wherein
I represents the rate of corrosion inhibition (in percent)
V₀ represents the corrosion rate of a non-treated steel wire with V₀=1/Rp
V represents the corrosion rate of a treated steel wire, with V=1/Rp

Example 1 comprises a non-treated steel wire. In examples 2 to 8, the application solution comprises 0.1 M of ICP monomer pyrrole in water to which several negative groups are added.

The composition of the application solution of the different examples is shown in Table 1.

During the application of the coating layer a constant current of 1.25 mA/cm² is applied.

After the application of the coating layer, Rp was measured in a solution of 0.05 M K₂SO₄. The percentage corrosion inhibition was calculated based on the non-treated steel wire. The percentage corrosion inhibition is given in the last column of Table 1.

TABLE 1
Corrosion inhibition (expressed as % corrosion
inhibition compared to non-treated steel wire)

| | | | | | Corrosion |
|---|---|---|---|---|---|
| | | | | | inhibition |
| | Concentration in the application solution | | | | (%) |
| Example 1 | / | / | / | / | 0 |
| Example 2 | 0.1M | 0.1M | / | / | 18.1 |
| | pyrrole | oxalic acid | | | |
| Example 3 | 0.1M | 0.1M | 0.1M Na | / | 90.5 |
| | pyrrole | oxalic acid | formiate | | |
| Example 4 | 0.1M | 0.1M | 0.1M Na H | / | 88.5 |
| | pyrrole | oxalic acid | phosphate | | |
| Example 5 | 0.1M | 0.1M | 0.1M K | / | 71.4 |
| | pyrrole | oxalic acid | nitrate | | |
| Example 6 | 0.1M | 0.1M | 0.1M | / | 71.9 |
| | pyrrole | oxalic acid | phosphoric | | |
| | | | acid | | |
| Example 7 | 0.1M | 0.1M | 0.1M | 0.1 M NaH | 82.4 |
| | pyrrole | oxalic acid | citric acid | phosphate | |
| Example 8 | 0.1M | 0.1M K H | | | −4.2 |
| | pyrrole | phtalate | | | |

In examples 10 to 12 the adhesion between a steel wire coated with a coating layer according to the present invention to four different standard rubber compounds used for car and truck tyre manufacturing is determined and compared with the adhesion obtained between a non-treated steel wire and these rubber compounds (example 9).

The steel wires are manufactured as described above.

The coating layer of examples 10 to 12 is applied by a method as shown in FIG. 4.

The coating layer of example 10 is applied from an application solution comprising 0.1 M of ICP monomer pyrrole with 0.1 M oxalate.

The coating layer of example 11 and 12 is applied from an application solution comprising 0.1 M of ICP monomer pyrrole, 0.1 M oxalate and 0.1 M thiophene.

In example 11, the bath circulation was high, whereas in example 12 the bath circulation was low.

During application a constant current of 1.25 mA/cm² is applied.

Adhesion between the metal element and the polymer material is determined as follows.

A non-treated steel wire and a steel wire coated with a coating layer according to the present invention are embedded in an industrial rubber composition. Subsequently, the rubber comprising the steel wires is vulcanised.

Both steel wires are pulled out from the vulcanised rubber. The forces necessary to pull out the steel wires are measured. By comparing the forces needed to pull out the “adherence loss rating” is determined. Such a test has been carried out according to ASTM D229-(93) “Standard test method for adhesion between steel tire cores and rubber” and according to BISFA (The International Bureau for the standardisation of man-made fibres) No. E12 (“Determination of static adhesion to rubber compound”).

The adhesion results are shown in table 2.

TABLE 2
adhesion tested as pull out force (expressed in Newton)

| | Compound 1 | Compound 2 | Compound 3 | Compound 4 |
|---|---|---|---|---|
| Example 9 | 160 | 201 | 566 | 307 |
| Example 10 | 221 | 332 | 656 | 287 |
| Example 11 | 510 | 1213 | 832 | 789 |
| Example 12 | 286 | 145 | 487 | 132 |

1. A metal element coated at least partially with a self-assembled coating layer, said self-assembled coating layer comprising an inherently conductive polymer and at least one negative group, whereby said inherently conductive polymer is functioning as a backbone structure for said negative group.

2. A metal element according to claim 1, whereby said self-assembled coating layer is formed by electrochemical anodic polymerisation starting from a solution of a monomer of an inherently conductive polymer and at least one dopant, said negative group being derived from said dopant.

3. A metal element according to claim 2, whereby said metal element is functioning as anode during said polymerisation.

4. A metal element according to claim 1, whereby said inherently conductive polymer is selected from the group consisting of polyaniline, polypyrrole, polythiophene, polyphenylenevinylene, polydiacetylene, polyacetylene, polyquinoline, polyphenylenevinylene, polyheteroarylenvinylene and derivatives, copolymers and mixtures thereof.

5. A metal element according to claim 1, whereby said negative group comprises an inorganic or organic negative group.

6. A metal element according to claim 1, whereby said self-assembled coating layer has a thickness between 1 nm and 1000 nm.

7. A metal element according to claim 1, whereby said said self-assembled coating layer has a thickness between 10 and 100 nm and a porosity of less than 1%.

8. A metal element according to claim 1, whereby said self-assembled coating layer comprising an inherently conductive polymer and at least one negative group is functioning as a backbone structure for at least one positive group or ion.

9. A metal element according to claim 8, whereby said positive ion is selected from the group consisting of the transition elements of the periodic table of elements, the earth alkali elements and the elements from group III and IV.

10. A metal element according to claim 1, whereby said metal element comprises an elongated metal element.

11. A metal element according to claim 10, whereby said elongated metal element comprises a metal wire, a metal cord or a metal tape.

12. A metal element according to claim 1, whereby said metal element comprises a structure comprising at least one elongated metal element.

13. A metal element according to claim 12, whereby said structure comprises a woven, non-woven, braided, knitted or welded structure.

14. A metal element according to claim 1, whereby said metal element is coated with a metal or metal alloy coating.

15. A metal element according to claim 14, whereby said metal or metal alloy comprises zinc or a zinc alloy.

16. An article comprising at least one element as defined in claim 1 embedded in a polymer material.

17. An article according to claim 16, whereby said polymer material comprises a thermoplastic material.

18. A method to coat a metal element with a self-assembled coating layer by electrochemical anodic polymerisation starting from a solution of a monomer of an inherently conductive polymer and at least one dopant, said self-assembled coating layer comprising an inherently conductive polymer and at least one negative group, whereby said inherently conductive polymer is functioning as a backbone structure for said negative group and said negative group being derived from said dopant.

19. A method according to claim 18, whereby said metal element is functioning as anode.

20. A method to improve the corrosion resistance of a metal element by applying a self-assembled layer, said self-assembled layer comprising an inherently conductive polymer and at least one negative group, whereby said inherently conductive polymer is functioning as a backbone structure for said negative group and whereby said negative group is chosen in such a way to increase the corrosion resistance of the metal element.

21. A method according to claim 20, whereby said negative group is selected from the group consisting of phosphates, chromates, nitrates, oxalates, benzoates and citrates.

22. A method to improve the adhesion of a metal element to a polymer material by applying a self-assembled coating layer on a metal element and embedding said metal element with said self-assembled coating layer in a polymer material, said self-assembled coating layer comprising an inherently conductive polymer and at least one negative group, whereby said self-assembled coating layer is functioning as a backbone structure for at least one positive group or ion and whereby said positive group or ion is chosen in such a way to improve the adhesion with said polymer material.

23. A method according to claim 22, whereby said polymer material comprises a thermoplastic material.

24. A method according to claim 22, whereby said positive ion is selected from the group consisting of the transition elements of the periodic table of elements, the earth alkali elements and the elements from group III and IV.
